(19) United States
(12) Patent Application Publication
(10) Pub. No.: US 2024/0392052 A1
(43) Pub. Date: Nov. 28, 2024

(54) METHOD FOR PREPARING A COPOLYMER OF (METH)ACRYLIC ACID AND A CYCLIC KETENE ACETAL

(71) Applicants: Rohm and Haas Company, Collegeville, PA (US); Dow Global Technologies LLC, Midland, MI (US)

(72) Inventors: Ligeng Yin, Collegeville, PA (US); Matthew Carter, Bala Cynwyd, PA (US); Stephanie Barbon, Midland, MI (US); Wen-Shiue Young, Blue Bell, PA (US); James Defelippis, Perkiomenville, PA (US)

(21) Appl. No.: 18/692,612

(22) PCT Filed: Nov. 1, 2022
(86) PCT No.: PCT/US2022/048517

§ 371 Date: Mar. 15, 2024

Related U.S. Application Data
(63) Continuation of application No. 63/275,590, filed on Nov. 4, 2021.

(51) Int. Cl. C08F 220/18

(52) U.S. Cl. CPC C08F 220/1804; C08F 2800/10; C08F 2810/00

(57) ABSTRACT

The present invention relates to a method for preparing a copolymer comprising structural units of acrylic acid and a cyclic ketene acetal monomer. The copolymer is useful as a biodegradable dispersant.

### BACKGROUND OF THE INVENTION

The present invention relates to a method of preparing a copolymer of (meth)acrylic acid and a cyclic ketene acetal, more specifically an aqueous solution of acrylic acid and 2-methylene-1,3-dioxepane (MDO).

Low molecular weight (MW) polyacrylic acid (PAA) is widely used as a dispersant and a scale-inhibitor in the home care and oil and gas industries. In these applications, PAA generally enters a municipal wastewater treatment plant or is at least partially released into the environment after use. Growing scrutiny from governments, regulatory bodies, companies, and consumers on the fate of polymers in the environment has necessitated the discovery of new, biodegradable materials. Past work has established that PAA is difficult to biodegrade, in part due to the inert nature of its carbon-carbon backbone. On the other hand, PAA oligomers having a molecular weight of less than 1000 g/mole are susceptible to biodegradation. (See Kawai, F., Bacterial Degradation of Acrylic Oligomers and Polymers, Applied Microbiology and Biotechnology 1993, 39 (3), 382-385; Hayashi, T.; Mukouyama, M.; Sakano, K.; Tani, Y., Degradation of a Sodium Acrylate Oligomer by an Arthrobacter sp. Appl Environ Microbiol 1993, 59 (5), 1555-9; Larson, R. J.; Bookland, E. A.; Williams, R. T.; Yocom, K. M.; Saucy, D. A.; Freeman, M. B.; Swift, G., Biodegradation of Acrylic Acid Polymers and Oligomers by Mixed Microbial Communities in Activated Sludge, Journal of environmental polymer degradation 1997, 5 (1), 41-48.) Nevertheless, these biodegradable oligomers are inadequate as dispersants and scale-inhibitors. Strategies for incorporating labile linkages in PAA polymers have been reported. For example, U.S. Pat. No. 4,923,941 (Bailey) discloses the aqueous preparation of a biodegradable MDO-AA copolymer by reacting sodium acrylate with MDO in water containing tetrabutylammonium bromide. Similarly, Guo et al (Guo) reports the preparation of MDO-AA copolymers by reacting incompletely neutralized acrylic acid with MDO in water also containing tetrabutylammonium bromide (Acta Polymerica Sinica 2012, 12, 958-964). Bailey asserts that the evidence of copolymer formation can be confirmed by “the presence of ester linkages in the copolymer chain.” In similar fashion, Guo assigns a triplet peak at 6=4.00 ppm of the disclosed proton NMR spectrum of the polymer product to methylene protons associated with MDO structural units. Notwithstanding Bailey's and Guo's claims, however, the present inventors have confirmed that no detectable amounts of MDO-AA copolymer can be formed by the analogous methods disclosed by Bailey and Guo et al.

Accordingly, there is still a need in the art of biodegradable dispersants to discover a way to prepare a PAA that is biodegradable yet still effective as a dispersant and scale-inhibitor.

### SUMMARY OF THE INVENTION

The present invention addresses a need in the art by providing a method for preparing a copolymer comprising structural units of a cyclic ketene monomer and (meth)acrylic acid comprising the steps of:
a) gradually adding to a reactor vessel, and in the presence of an organic solvent, a cyclic ketene acetal monomer and t-butyl (meth)acrylate; and concurrently and separately gradually adding an initiator to the reactor vessel;
wherein the contents of the reaction vessel are heated to a temperature sufficient to promote polymerization of the cyclic ketene acetal monomer and t-butyl (meth)acrylate to yield a solution of a copolymer of the cyclic ketene acetal monomer and t-butyl (meth)acrylate; then
b) contacting the copolymer of the cyclic ketene acetal monomer and t-butyl (meth)acrylate with a deprotection agent to form the copolymer of the cyclic ketene acetal monomer and (meth)acrylic acid;
wherein the mole:mole ratio of the t-butyl (meth)acrylate to the cyclic ketene acetal monomer in the first and second portions is in the range of from 2:1 to 15:1; and
wherein the cyclic ketene acetal monomer has the following structure:

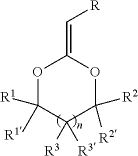

where n is 0, 1, or 2;
R is H or C₁-C₆-alkyl;
R¹ and R² are each independently H, C₁-C₁₂-alkyl, phenyl, or vinyl; or R¹ and R² together with the carbon atoms to which they are attached, form a fused benzene ring or a fused C₃-C₇-cycloaliphatic ring; and
R^{1′} and R^{2′} are each independently H or C₁-C₁₂-alkyl; or R¹ and R^{1′} and/or R² and R^{2′} form an exocyclic double bond;
with the proviso that when n is 1:
R³ and R^{3′} are each independently H, C₁-C₁₂-alkyl, phenyl, or R³ and R^{3′} form an exocyclic double bond or a spirocycloaliphatic group or a spiro-2-methylene-1,3-dioxepane group;
with the further proviso that when n is 2:
each R³ is independently H, C₁-C₁₂-alkyl, or together with the carbon atoms to which they are attached form an internal double bond, a fused benzene ring, or a fused C₃-C₇-cycloaliphatic ring.

The process of the present invention provides a copolymer of acrylic acid that is biodegradable, yet effective as a dispersant.

### DETAILED DESCRIPTION OF THE INVENTION

The present invention is a method for preparing a copolymer comprising structural units of a cyclic ketene acetal monomer and (meth)acrylic acid comprising the steps of:
a) gradually adding to a reactor vessel, and in the presence of an organic solvent, a cyclic ketene acetal monomer and t-butyl (meth)acrylate; and concurrently and separately gradually adding an initiator to the reactor vessel;
wherein the contents of the reaction vessel are heated to a temperature sufficient to promote polymerization of the cyclic ketene acetal monomer and t-(meth)butyl acrylate to yield a solution of a copolymer of the cyclic ketene acetal monomer and t-(meth)butyl acrylate; then
b) contacting the copolymer of the cyclic ketene acetal monomer and t-(meth)butyl acrylate with a deprotection agent to form the copolymer of the cyclic ketene acetal monomer and (meth)acrylic acid;
wherein the mole:mole ratio of the t-butyl (meth)acrylate to the cyclic ketene acetal monomer in the first and second portions is in the range of from 2:1 to 15:1; and
wherein the cyclic ketene acetal monomer has the following structure:

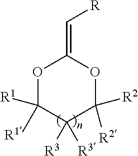

where n is 0, 1, or 2;
R is H or C₁-C₆-alkyl;
R¹ and R² are each independently H, C₁-C₁₂-alkyl, phenyl, or vinyl; or R¹ and R² together with the carbon atoms to which they are attached, form a fused benzene ring or a fused C₃-C₇-cycloaliphatic ring; and
R^{1′} and R^{2′} are each independently H or C₁-C₁₂-alkyl; or R¹ and R^{1′} and/or R² and R^{2′} form an exocyclic double bond;
with the proviso that when n is 1:
R³ and R^{3′} are each independently H, C₁-C₁₂-alkyl, phenyl, or R³ and R^{3′} form an exocyclic double bond or a spirocycloaliphatic group or a spiro-2-methylene-1,3-dioxepane group; with the further proviso that when n is 2:
each R³ is independently H, C₁-C₁₂-alkyl, or together with the carbon atoms to which they are attached form an internal double bond, a fused benzene ring, or a fused C₃-C₇-cycloaliphatic ring.

As used herein, the term “structural unit of (meth)acrylic acid refers to a polymer backbone containing the following repeat units:

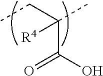

or a salt thereof; where R⁴ is H or CH₃, preferably H.

The term “structural unit of a cyclic ketene acetal monomer” refers to a polymer backbone containing the following repeat unit:

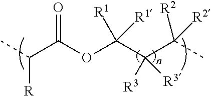

### Structural Unit of a Cyclic Ketene Acetal Monomer

where R, R¹, R², R³, R^{1′}, R^{2′}, R^{3′}, and n are as previously defined.

Examples of cyclic ketene acetal monomers include:

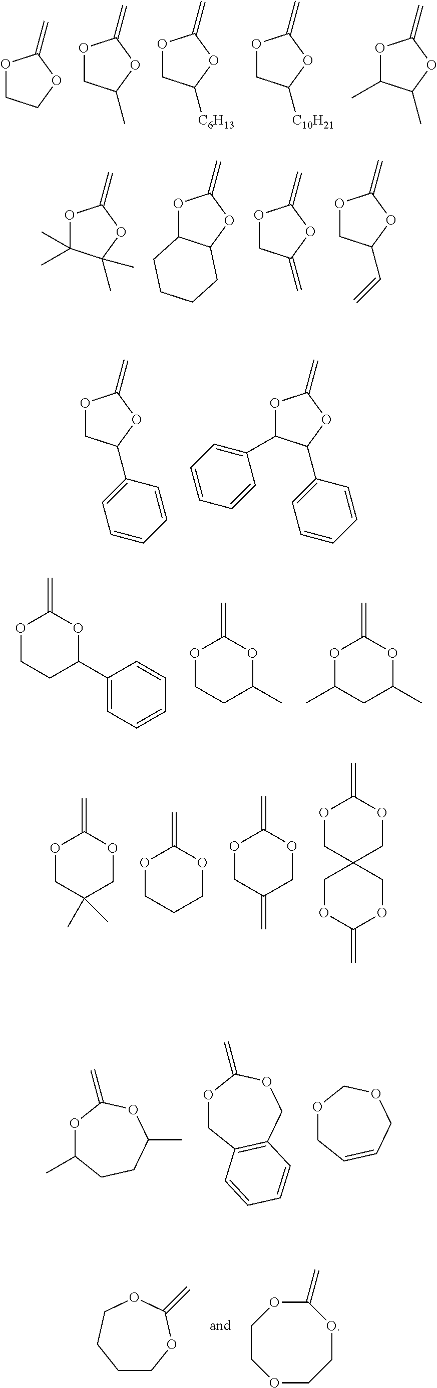

A preferred cyclic ketene acetal monomer is 2-methylene-1,3-dioxepane (MDO).

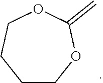

The copolymer of the cyclic ketene acetal monomer and acrylic acid is prepared in multiple steps. In a first step, a mixture of the cyclic ketene acetal monomer and t-butyl (meth)acrylate, preferably t-butyl acrylate, is gradually added from a vessel for the monomers (monomer vessel) to a reaction vessel in the presence of an organic solvent. Concurrently, an initiator, which is also advantageously diluted in the same organic solvent as used for the monomers, is gradually added to the reaction vessel from a vessel for the initiator (initiator vessel). It may be desirable to gradually add the mixture of monomers and the initiator to a reaction vessel containing solvent and a small amount of the monomers, which is generally on the order of 10 to 30 weight percent of the total monomers used to prepare the copolymer.

Suitable organic solvents include aliphatic esters such as ethyl acetate; ethers such as tetrahydrofuran and 1,4-dioxane; alkanes such as pentane, hexane, and isododecane; and aromatic solvents such as benzene, toluene, and xylene. Examples of suitable initiators include t-amyl peroxypivalate (commercially available as Trigonox 125-C75 initiator), t-butyl peroxypivalate (commercially available as Trigonox 25-C75), t-amyl peroxy-2-ethylhexanoate; 2,2′-azobis(2-methylbutyronitrile), and dimethyl 2,2′-azobis(2-methyl propionate).

A chain transfer agent such as n-dodecyl mercaptan may also be added concurrent with the monomers and initiator to control the molecular weight of the intermediate and final copolymers.

The contents of the reaction vessel are heated to a temperature sufficient to promote copolymerization of the cyclic ketene acetal monomer and t-butyl (meth)acrylate, generally in the range of from 40° C., or from 50° C., to 150° C., or to 100° C., or to 80° C., to yield a solution of an intermediate copolymer of the cyclic ketene acetal monomer and t-butyl (meth)acrylate.

In a second step, the intermediate copolymer is reacted under deprotection conditions to convert t-butyl pendant groups of the copolymer to carboxylic acid groups or salts thereof, thereby forming a solution of a copolymer of the cyclic ketene acetal monomer and (meth)acrylic acid, preferably acrylic acid, or a salt thereof. Deprotection conditions include contacting the intermediate copolymer with an organic acid having pKₐ preferably in the range of from −2 or −1, to 2 or to 1. Examples of acids suitable for deprotection include trifluoroacetic acid, p-toluenesulfonic acid, trifluoromethanesulfonic acid, and methanesulfonic acid. The organic solution of the copolymer of the cyclic ketene acetal monomer and acrylic acid can then be converted to an aqueous solution of the copolymer of the cyclic ketene acetal monomer and acrylic acid by conventional means such as in vacuo removal of solvents followed by dissolution in water, or by in vacuo removal of solvents followed by dissolution in water, lyophilization, and subsequent re-dissolution in water.

Where the cyclic ketene acetal monomer is MDO, the MDO-AA copolymer has been found to contain two kinds of structural units of MDO, one that is degradable by treatment with a base, and the other that is not readily degradable by treatment with base, as illustrated:

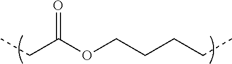

Structural unit of 2-methylene-1,3-dioxepane—degradable unit

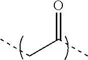

Structural unit of 2-methylene-1,3-dioxepane—non-degradable unit

For the copolymer to be useful for the purposes of the present invention, it must contain degradable structural units the cyclic ketene acetal monomer; although formation of the non-degradable structural units is undesirable, it has proven to be difficult to prepare copolymers without some residual concentration of the non-degradable form.

The mole-to-mole ratio of structural units of (meth)acrylic acid to the sum structural units of the cyclic ketene acetal monomer (both degradable and non-degradable), preferably MDO, is in the range of from 2:1, or from 3:1, or from 4:1; to 15:1, or to 10:1, or to 8:1 or to 7:1. Preferably, the M. of the desired copolymer is in the range of from 1500 g/mole to 20,000, or to 15,000, or to 10,000 g/mole. Statistically, the polymer backbone is expected to comprise from 2 to 15 structural units of (meth)acrylic acid (preferably fragments of acrylic acid groups) anchored on each end by a single degradable structural unit of the cyclic ketene acetal monomer, as illustrated:

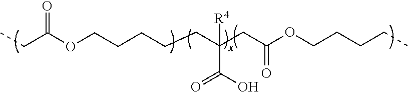

where R⁴ is H or CH₃, preferably H; x is in the range of from 2, or from 3, or from 4, to 15, or to 10, or to 8 or to 7; and wherein the dotted lines represent the attachment of the structural unit of the MDO to another fragment of acrylic acid groups.

In an accelerated degradation study, the ester groups are hydrolyzed with a strong base such as KOH to give, in part, a distribution of oligomers including oligomers presumed to have the following structure:

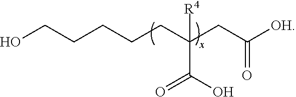

The presence of non-degradable structural units of the cyclic ketene acetal monomer are expected to form copolymers that are hydrolyzable to the following oligomers:

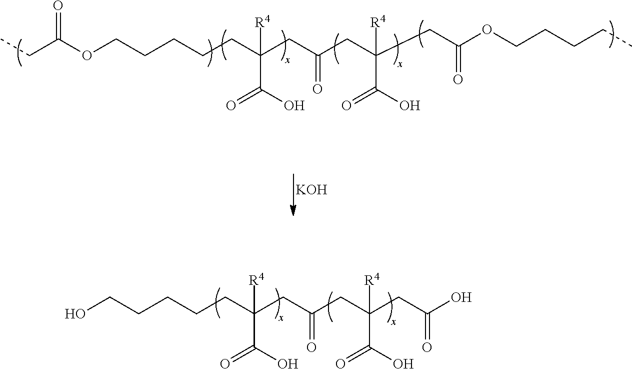

While the exact structures of the oligomers are open to speculation, it can be determined with greater confidence that the number average molecular weight (Mₙ) of hydrolyzed copolymer, as measured by gel permeation chromatography by the method detailed in the Example section, is in the range of from 144, or from 200, or from 400, or from 500 g/mole, to 1000, or to 800, or to 750 g/mole.

Although the composition of the present invention was ostensibly disclosed in U.S. Pat. No. 4,923,941 (Bailey), a repeat of the procedure of Bailey's sole example and proton NMR spectroscopic analysis demonstrated that Bailey's interpretation of the data was erroneous; in fact, no copolymer of MDO and AA can be prepared by the disclosed example.

The example of Bailey was repeated as described, and a proton NMR spectrum of a reaction mixture of sodium acrylate and MDO was recorded after reaction for 30 minutes at 90° C. Triplets at 4.02 ppm and 3.52 ppm were observed, which were consistent with the hydrolyzed product of MDO, 4-hydroxybutyl acetate:

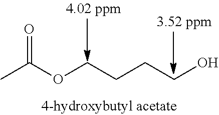

Small triplets at the same resonances were also observed in the proton NMR spectrum of the isolated product. Confirmation that these residual peaks could not be attributable ester formation of a copolymer was demonstrated by diffusion edited proton NMR spectroscopy, which suppresses the chemical shifts of small molecules and reveals only chemical shifts associated with polymers. Significantly, no chemical shifts were observed near 4 ppm, confirming that Bailey could not have formed any detectable levels of a copolymer of AA and MDO by the disclosed method. Moreover, it was further confirmed by proton NMR spectroscopy that MDO hydrolyzed to 4-hydroxybutyl acetate (among other byproducts) under the initial reaction conditions reported by Bailey at room temperature.

Similarly, in Acta Polymerica Sinica 2012, 12, 958-964, Guo claims to have prepared MDO-AA copolymers by reacting incompletely neutralized acrylic acid with MDO in water containing tetrabutylammonium bromide. The method of Guo was repeated as described, and additional experiments were done using acrylic acid at various degrees of neutralization. The method described by Guo could not be reproduced to obtain proton NMR spectroscopic patterns that matched those reported by Guo. On the contrary, NMR spectroscopy showed no detectable amounts of the MDO-AA copolymer. Proton NMR and diffusion NMR spectroscopy revealed a small, sharp triplet resonance at 4.0 ppm, not (as Guo concludes) indicative of the formation of structural units of MDO, rather, characteristic of MDO hydrolysis products, such as 4-hydroxybutyl acetate.

In contrast, copolymers prepared by the process of the present invention and analyzed by diffusion edited proton NMR spectroscopy revealed a strong, broad chemical shift near 4 ppm, consistent with the expected profile of a copolymer containing structural units of a cyclic ketene acetal monomer. The composition prepared by the process of the present invention is useful as a biodegradable dispersant and scale inhibitor.

### Examples

### Mₙ Determinations

Aqueous samples were prepared for gel permeation chromatography (GPC) at a concentration of about 2 mg/mL in an aqueous 20 mM phosphate buffer at pH 7. The separation was performed on a Waters UPLC system equipped with a refractive index detector, and the same phosphate buffer was used as the mobile phase. An APC column set composed of a TOSOH Bioscience TSKgel G2500PW×1 7.8 mm ID×30 cm, 7-μm column and a TOSOH Bioscience TSKgel GMPW×1 7.8 mm ID×30 cm, 13-μm was used. The flow rate was maintained at 1.0 mL/min and the column temperature at 35° C. Results were calibrated with narrow pAA standards of a peak molecular weight (Mₚ) of 216 g/mol to 1,100,000 g/mol, fitted with a quadratic calibration curve. Standards 1-15 were obtained from American Polymer Standards and standard 16 (AA trimer with Mₚ=216) was prepared internally. The flow rate was 1.0 mL/min and the column temperature was maintained at 35° C. Results were calibrated with narrow pAA standards of a peak molecular weight (Mₚ) of 216 g/mol to 1,100,000 g/mol, fitted with a quadratic calibration curve. Empower Version 3 software (Waters Corporation) was used to calculate Mₙ of the example copolymers.

The GPC calibration table showing retention times of the 16 standards are shown in Table 1.

TABLE 1
GPC Calibration Curve

| | Mol Wt | Retention |
|---|---|---|
| | (g/mol) | Time (min) |
| 1 | 1100000 | 11.004 |
| 2 | 782200 | 11.291 |
| 3 | 585400 | 11.532 |
| 4 | 323000 | 11.786 |
| 5 | 193800 | 12.027 |
| 6 | 115000 | 12.397 |
| 7 | 62900 | 12.525 |
| 8 | 47500 | 12.589 |
| 9 | 28000 | 12.747 |
| 10 | 16000 | 13.103 |
| 11 | 7500 | 13.324 |
| 12 | 4100 | 13.473 |
| 13 | 2925 | 13.565 |
| 14 | 1770 | 13.676 |
| 15 | 900 | 13.901 |
| 16 | 216 | 14.613 |

### Proton NMR Spectoscopic Analysis

Proton NMR spectra were obtained using a Bruker NEO 600 MHz spectrometer, equipped with a 5-mm BBO CryoProbe using Bruker zg30 pulse sequences. The relaxation delay for was 12 s. Pulse Field Gradient NMR spectroscopic experiments were carried out using a Bruker ledbpgp2s1d pulse sequence with a gradient pulse length of 2 ms and a delay time of 20 ms.

### Example 1—Preparation of MDO-AA Copolymer

The following procedures were used to prepare a copolymer of MDO and acrylic acid at approximately a 1:4 mole:mole ratio of MDO:AA structural units.

A. Preparation of MDO-t-Butyl Acrylate Copolymer (1:4 Mole:Mole ratio of MDO:t-Butyl Acrylate)

A three-neck, 250-mL round-bottom flask equipped with a condenser, a stir bar, a thermocouple, and a Y-shaped glass adapter for two polyethylene feed lines was charged with ethyl acetate (18.0 g) and placed on an Opti-chem hotplate stirrer heated to 75° C. A blanket of N2 was applied to remove entrained air, and agitation was set to 300 rpm. A monomer vessel was charged with t-butyl acrylate (24.55 g), MDO (5.45 g), and n-dodecylmercaptan (0.90 g), and an initiator vessel was charged with Trigonox 125-C75 initiator (0.40 g, 75% active in mineral spirits) in 7.50 g of ethyl acetate (7.50 g). A portion of the contents of the monomer vessel (6.18 g) was added to the reaction flask over 2 min. A few minutes later, the rest of the contents of the monomer vessel and the contents of the initiator vessel were metered into the reaction flask at the rates of 0.275 g/min and 0.088 g/min, respectively, so that addition of the contents of the initiator vessel and the remainder of the monomer vessel was complete at 90 min. The monomer vessel was rinsed with ethyl acetate (4.50 g), which was added to the reaction flask. After 15 min, a portion of Trigonox 125-C75 initiator (0.60 g) in ethyl acetate (2.25 g) was metered into reaction flask over 30 min, followed by a 15-min hold, followed by a second addition of the same amount of initiator, also metered into the reaction flask over 30 min. Heating and stirring of the contents of the reaction flask were continued for another 30 min, after which time the reaction was cooled to room temperature. The resultant copolymer was transferred to a glass container for storage without further purification. The solid content was found to be 41.42 wt %. The conversion of both t-butyl acrylate and MDO were determined to be quantitative by proton NMR spectroscopy.

### B. Deprotection of MDO-t-Butyl Acrylate Copolymer

A portion of the copolymer prepared from Part A (5.0 g) was transferred to a 1-oz glass vial fitted with a stir bar. The volatile content was removed by vacuum distillation, after which time the dried polymer was re-dissolved in methylene chloride (CH₂Cl₂, 8.0 g). Trifluoroacetic acid (TFA, 4.4 g) was added dropwise to the stirred contents of the vial. Upon completion of addition, the vial was capped, and reaction mixture was stirred at ambient temperature for 18 h. A slightly yellow opaque mixture was obtained.

Volatiles were removed in vacuo then anhydrous tetrahydrofuran (THF, 5.0 g) was added to redissolve the reaction mixture. Volatiles were once again removed in vacuo and the resultant crude product (2.68 g) was dissolved in deionized water (10.26 g) and neutralized with 1 N NaOH solution (5.73 g) to afford a clear solution with a pH of 5.86. The neutralized polymer was dialyzed against deionized water inside dialysis tubes with a molecular weight cutoff (MWCO) of 100-500 g/mol to remove small-molecule impurities. Lyophilization of the dialyzed solution afforded fluffy, white polymer as the final product. The Mₙ of the product by GPC described hereinabove was 2060 g/mol (polydispersity 4.66). Using proton NMR spectroscopy, the ester content was found to be 18 weight %, ester retention in the polymer backbone was found to be 80 weight %, and residual t-butyl groups in the backbone was found to be 3 weight %.

### Example 2—Preparation of MDO-AA Copolymer

The procedures used to prepare MDO-AA copolymer of Example 2 were substantially the same as described for the preparation of the MDO-AA copolymer of Example 1 except that, for Part A, the amounts of t-butyl acrylate (26.62 g), and MDO (3.38 g), and n-dodecylmercaptan (0.34 g) were altered to ultimately produce an MDO-AA copolymer with an MDO:AA mole:mole ratio of ˜1:7 and an Mₙ of 4080 g/mol (polydispersity 4.61).

### Biodegradation Simulation

The MDO-t-butyl acrylate copolymer of Example 1A was subjected to exhaustive hydrolysis to simulate biodegradation potential of the MDO-AA copolymer as follows. General-purpose acid-digestion Parr bombs with 23 mL PTFE cups were charged with 4-5 KOH pellets, about polymer solution (1 g, ˜40 wt % solids), and ethanol (10 g). The bombs were tightly sealed, transferred to a 150° C. oven, and equilibrated for 3 d. The bombs were removed from the oven and allowed to cool to ambient temperature. Disassembly of the bombs revealed the presence of a liquid portion and a solid portion. The liquid portion was separated and discarded, and the solid portion was diluted with about 5 g of water. The resultant polymer solutions were analyzed by GPC described hereinabove and the Mₙ of the hydrolyzed polymers was found to be 677 g/mole. The hydrolysis studies predict a dramatic reduction in molecular weight from useful MDO-AA copolymers, to biodegradable oligomers.

1. A method for preparing a copolymer comprising structural units of a cyclic ketene acetal monomer and (meth)acrylic acid comprising the steps of:
a) gradually adding to a reactor vessel, and in the presence of an organic solvent, a cyclic ketene acetal monomer and t-butyl (meth)acrylate; and concurrently and separately gradually adding an initiator to the reactor vessel;
wherein the contents of the reaction vessel are heated to a temperature sufficient to promote polymerization of the cyclic ketene acetal monomer and t-butyl (meth)acrylate to yield a solution of a copolymer of the cyclic ketene acetal monomer and t-butyl (meth)acrylate; then
b) contacting the copolymer of the cyclic ketene acetal monomer and t-butyl (meth)acrylate with a deprotection agent to form the copolymer of the cyclic ketene acetal monomer and (meth)acrylic acid;
wherein the mole:mole ratio of the t-butyl (meth)acrylate to the cyclic ketene acetal monomer in the first and second portions is in the range of from 2:1 to 15:1; and
wherein the cyclic ketene acetal monomer has the following structure: 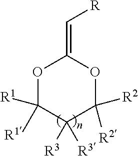
where n is 0, 1, or 2;
R is H or C₁-C₆-alkyl;
R¹ and R² are each independently H, C₁-C₁₂-alkyl, phenyl, or vinyl; or R¹ and R² together with the carbon atoms to which they are attached, form a fused benzene ring or a fused C₃-C₇-cycloaliphatic ring; and
R^{1′} and R^{2′} are each independently H or C₁-C₁₂-alkyl; or R¹ and R^{2′} and/or R² and R^{2′} form an exocyclic double bond;
with the proviso that when n is 1:
R³ and R^{3′} are each independently H, C₁-C₁₂-alkyl, phenyl, or R³ and R^{3′} form an exocyclic double bond or a spirocycloaliphatic group or a spiro-2-methylene-1,3-dioxepane group;
with the further proviso that when n is 2:
each R³ is independently H, C₁-C₁₂-alkyl, or together with the carbon atoms to which they are attached form an internal double bond, a fused benzene ring, or a fused C₃-C₇-cycloaliphatic ring.

2. The method of claim 1 wherein the cyclic ketene acetal monomer is selected from the group consisting of:

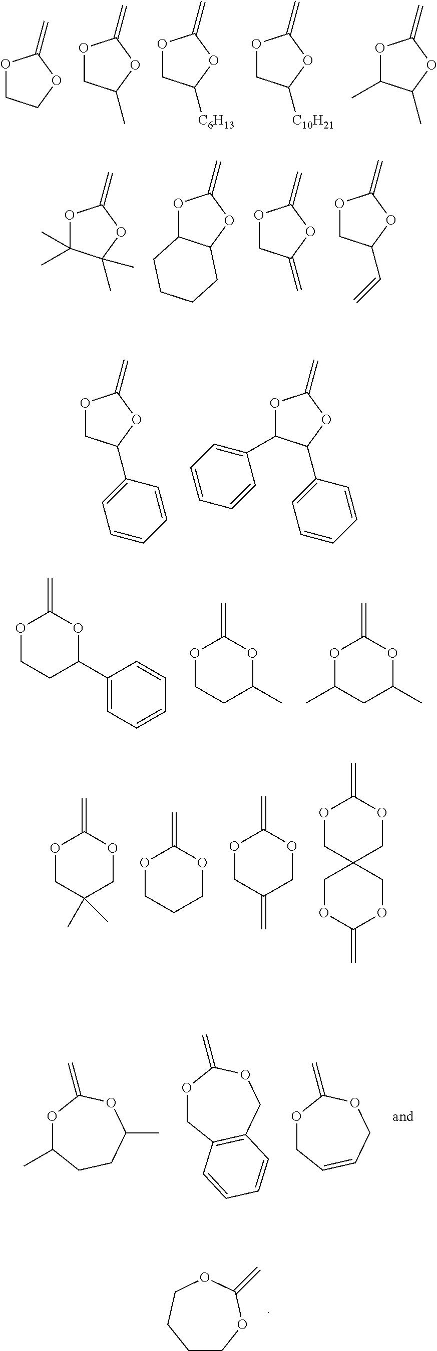

3. The method of claim 2 wherein the cyclic ketene acetal monomer is 2-methylene-1,3-dioxepane (MDO), the t-butyl (meth)acrylate is t-butyl acrylate, and the mole-to-mole ratio of t-butyl acrylate to MDO is in the range of from 3:1 to 8:1.

4. The method of claim 3, wherein in step (a), a chain transfer agent is gradually added to the reaction vessel along with the second portion of the monomers.

5. The method of claim 3 where the chain transfer agent is n-dodecyl mercaptan, and the temperature of the contents of the vessel in step (a) is in the range of from 40° C. to 150° C.

6. The method of claim 5 where the organic solvent is ethyl acetate, and the temperature of the contents of the vessel in step (a) is in the range of from 50° C. to 80° C.

7. The method of claim 1 wherein the t-butyl (meth)acrylate is t-butyl acrylate, and wherein after step (b), the organic solvent is removed, and the copolymer of the cyclic ketene acetal monomer and the acrylic acid are dissolved in water.

8. The method of claim 7 wherein the cyclic ketene acetal monomer is MDO, and wherein the MDO-AA copolymer is hydrolyzable to an oligomer having the following structure: 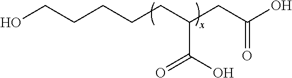
where x is in the range of from 2 to 15.

9. The method of claim 3 wherein the reactor vessel initially contains a first portion of MDO and t-butyl acrylate in an amount of from 10 to 30 weight percent of the total of MDO and t-butyl acrylate used in the reaction.
